(19) United States
(12) Patent Application Publication
(10) Pub. No.: US 2011/0141628 A1
(43) Pub. Date: Jun. 16, 2011

(54) LAMINATED MONOLITHIC POLYMER FILM DESICCANTS FOR MAGNETIC STORAGE DEVICES

(76) Inventor: Charles A. Brown, San Jose, CA (US)

(21) Appl. No.: 12/639,686

(22) Filed: Dec. 16, 2009

(51) Int. Cl. G11B 5/48; B32B 1/06; B32B 1/02; B32B 27/06; B32B 27/12; B32B 27/02

(52) U.S. Cl. 360/246.2; 428/34.1; 428/35.2; 428/36.1; 428/36.5; G9B/5.147

(57) ABSTRACT

A desiccant device that emits no contamination and is therefore suitable for use in an electronic device such as a magnetic disk drive system. The desiccant device includes a pouch formed of a laminate layer. The laminate layer includes a thin, non-permeable monolithic membrane laminated to a porous media. The thin, non-permeable monolithic membrane is thin enough to allow a desired vapor to pass there-through by molecular diffusion, but does not include any voids, pores or holes that would allow gas, liquid or solid to permeate there-through. Since the permeable membrane only passes vapor by molecular diffusion, it prohibits any dust fibers or other contamination from emitting from the desiccant device and thereby prevents contamination of the electronic device such as the disk drive.

### FIELD OF THE INVENTION

The present invention relates to desiccants, and more particularly to a desiccant for use in a magnetic data storage device.

### BACKGROUND OF THE INVENTION

Desiccants have been used for many years to prevent vapors such as water or other vapors from adversely affecting products stored within a container. In many applications simple desiccant structures such as an absorber material (e.g. silica) is held within a simple sealed paper pouch or bag. These desiccants are suitable for use in applications wherein contamination, such as from the absorbent material from the enclosing paper pouch, is not a serious issue. Examples of such commonly known applications include the storage of clothes, toys or even electronic devices in a box or other container during shipping and storage prior to sale.

Such simple desiccant structures have, however, proven entirely inadequate in applications where any debris or contamination is entirely unacceptable. An example of an environment where any sort of contamination cannot be tolerated is the interior of a disk drive device (HDD). As those skilled in the art of HDD construction can appreciate, any contamination within the interior of a disk drive device can lead to catastrophic failure of the device.

Modern disk drive devices include a magnetic read write head, mounted on a slider that flies at an extremely low fly-height over the surface of a magnetic disk. In many instances this fly height can be on the order of few nano-meters and is approaching even smaller dimensions. Therefore, a debris particle of only a few nano-meters in size when present in a disk drive device can cause a magnetic read write head to “crash”, by causing a head to disk contact. This can permanently damage the head and or the disk, rendering the disk drive useless and presenting the possibility of data loss. Therefore, the above described desiccant structure cannot be used in a device such as a disk drive, because particles such as dust from the absorbent may pass through the paper pouch and thereby contaminate the interior of the disk drive device. Furthermore, dust or particles (such as fibers) from the containment pouch itself can contaminate the interior of the disk drive.

On the other hand, vapors such as water vapors cannot be allowed to exist within the disk drive either. The presence of vapors such as water vapor or other vapors (such as from out-gassing of materials used within the disk drive device) can cause serious corrosion of the components within the disk drive (such as the sensitive read and write head formed on the slider).

As a result, some form of vapor absorbing mechanism is needed in the disk drive device. This vapor absorbing mechanism must be designed and constructed so as to ensure that it will not introduce any contamination whatsoever into the disk drive device. Similarly, in the highly competitive, low cost margin industry of data storage manufacture, such a mechanism must also be very inexpensive to manufacture.

### SUMMARY OF THE INVENTION

The present invention provides a desiccant device that includes a containment structure constructed of a laminate layer, the laminate layer comprising a permeable media layer and a thin monolithic membrane bonded to the permeable media layer. A vapor absorbing material held is held within the containment structure.

The thin monolithic membrane is designed to allow a desired vapor to pass there-through by molecular diffusion, but does not allow the passage of any material by any other mechanism, such as by the permeation of material through small holes or pores. The woven media is preferably a non-woven fabric such as spun bonded polypropylene. The monolithic membrane can be a material such as a thin layer of polymeric material, such as non-expanded polytetratluoroethane (PTFE).

By constructing the containment structure of a monolithic membrane, the device completely eliminates the risk that any contaminants from within the desiccant device will escape to contaminate the electronic device such as the disk drive.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a cross sectional view of a laminate structure for use as a containment structure of a desiccant device;

FIG. 2 is a cross sectional view of a layer of laminate bent into a “U” shape and filled with an absorbent material;

FIG. 3 is a cross sectional view of a desiccant device according to an embodiment of the invention;

FIG. 4 is a view of the desiccant device of FIG. 3, as seen from line 4-4 of FIG. 3;

FIG. 5 is an enlarged view of the desiccant device of FIG. 3 as seen from the circle designated 5 in FIG. 3;

FIG. 6 is a cross sectional view of a laminate layer according to an alternate embodiment of the invention; and

FIG. 7 is a view of a desiccant device according to an alternate embodiment of the invention.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

Desiccants for vapor absorption in certain applications such as the interior of a hard disk drive device (HDD) present significant challenges not present in other common applications in which desiccants are used. While such challenges are not unique to HDD products, the application of a desiccant device within a HDD provides an excellent example for discussing and describing such challenges.

HDD products are extremely susceptible to damage from contamination with the interior of such devices. HDD products generally include a hard magnetic disk which spins with the chamber. A slider (having a read/write head formed thereon) slides on a cushion of moving air adjacent to a surface of the disk. In current HDD devices, the slider flies at a very small fly height, on the order of only a few nanometers. Contamination particles of only a few nanometers can cause a catastrophic failure of the disk drive by causing the slider to crash, permanently damaging the magnetic head and/or disk.

In addition to being sensitive to debris a device such as a HDD must be free of vapor contamination, such water vapor or outgassing from materials within the HDD. Such vapor can cause corrosion of components such as the read and write head on the slider.

Therefore, a HDD device needs some form of desiccant device to remove vapors such as water vapors from the atmosphere within the HDD. However, any such desiccant device must not introduce any physical contamination into the HDD. No fibers or other particles from the containment structure can be tolerated. Similarly, no dust or other particles from the vapor absorbing structure can be tolerated within the HDD.

To this end, the present invention provides a desiccant structure that can remove vapor, such as water or other vapor, from the HDD while ensuring that no physical contamination is introduced into the HDD. While the invention described below has been described as being suitable for use in a HDD device it should be understood that it could also be suitable for use in other devices where vapor must be removed, but in which physical contamination cannot be tolerated.

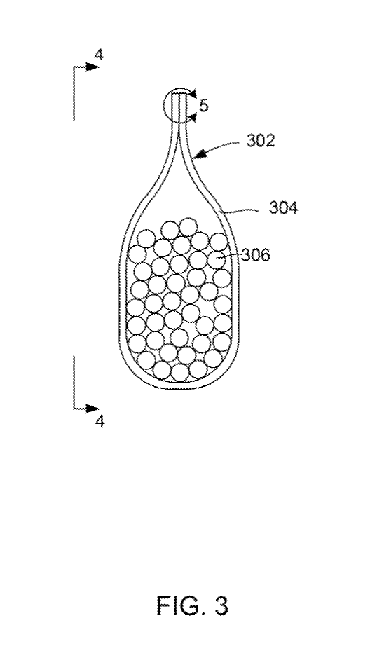

With reference now to FIG. 3, the desiccant device 302 can include a containment structure 304 and a vapor absorbing material 306 contained therein. The vapor absorbing material 306 can be in the form of small pellets of beads as shown (in order to maximize surface area of the vapor absorbing material 306) or could be in any number of other forms. The choice of material for use as a vapor absorbing material depends on the type of gas or vapor that is desired to be removed from the HDD device, such as but not limited to water vapor, organic vapors, and/or corrosive gases. If the vapor of concern is water vapor, then the vapor absorbing material can be silica gel. Other possible absorber materials 306 include activated carbon, or some other similar material. In addition the absorber 306 could be a combination of more than one type of absorber material.

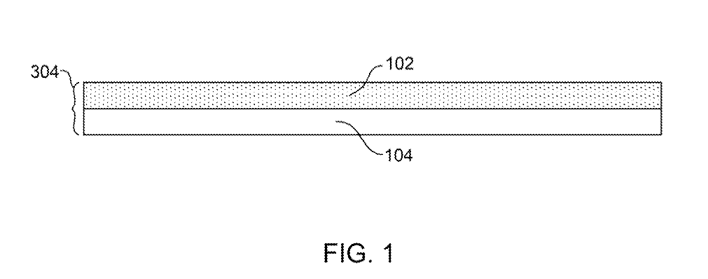

The nature of the containment structure 304 can be better understood with reference to FIG. 1. The containment structure 304 (FIG. 3) is constructed of a sheet of laminate material 304. This sheet includes a layer of porous media material 102 and a layer of thin monolithic membrane material 104 laminated to the porous media material 102.

The porous media material is a thin layer of largely continuous media that is penetrated by voids through which a fluid may flow under some pressure differential. The porous media is preferably a layer of non-woven fabric, such as (but not limited to) spun bonded polypropylene, which can be purchased under the trade name TYVEK®. The porous media material 102 provides structural strength (such as tensile strength and puncture resistance) to the device.

The other layer 104 is a thin, non-porous, monolithic layer of material formed such that it has no holes, slits or other gaps. It is contrasted with materials such as micro-porous, expanded, needle punched, air-laid non-woven, and other similar materials. In contrast with other materials used for desiccant containers, the layer 104 does not pass liquids or solids there-through by permeation (such as through very small holes). The membrane 104 passes a desired gas or vapor (such as water vapor) only by molecular diffusion. In this manner, no contamination can pass through the laminate layer 304 to contaminate the device (such as a disk drive) in which the desiccant is employed.

The material and thickness of the monolithic membrane layer 104 are chosen to provide a desired amount of molecular diffusion to pass the vapor or gas of interest at a desired rate through the laminate layer 304. For example, the monolithic film can be a thin polymeric film layer. It can be constructed of a material such as non-expanded polytetrafluoroethylene non-expanded (PTFE), although it can be constructed of various other materials as well, so long as the material is thin enough to pass the vapor of interest by molecular diffusion at a desired rate. It should also be pointed out that the non-expanded PTFE is a non-porous material having no voids or holes, whereas expanded PTFE is a material that has been formed with small holes a fluid or vapor there-through.

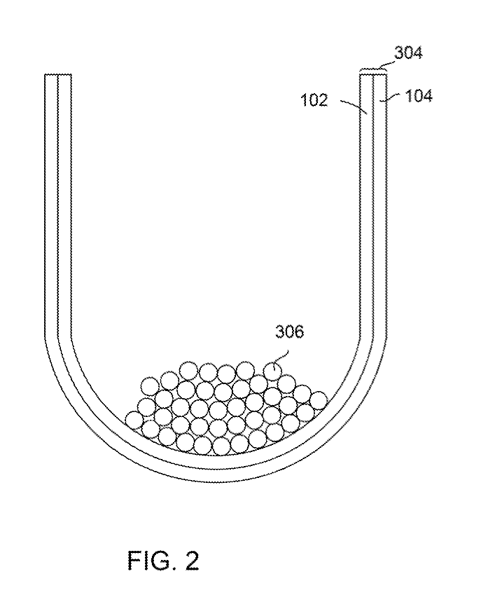

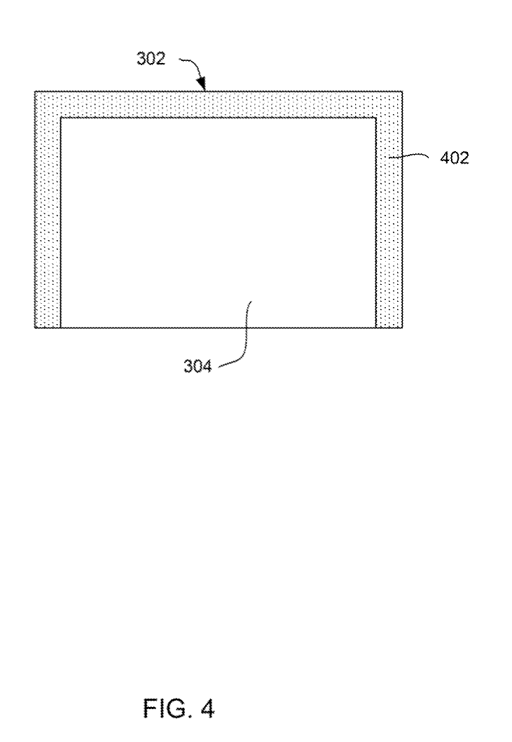

With reference to FIG. 2, the laminate layer 304 can be bent into a “U” shape as shown, and a desired amount of absorbent 306 can be placed into the bent laminate layer 304. As can be seen, the layer 304 is placed so that the porous media 102 is at the inside. The edges of the layer 304 can then be pressed together and sealed together by a method such as heat sealing. The sealed edges can be seen in FIG. 4, which shows a side view as seen from line 4-4 of FIG. 3. The sealed portion in FIG. 4 is indicated by the shaded area designated 402.

Various heat sealing processes are possible. For example, the heat sealing could be performed so that both layer 102, 104 are melted. On the other hand, the heat sealing can be performed so that only the inner layer 102 is melted, and the outer layer is not. Alternatively, the heat sealing can be performed so that the outer layer 104 is melted, but the inner layer 102 is not, such that the monolithic membrane layer 104 is melted into the porous media 102.

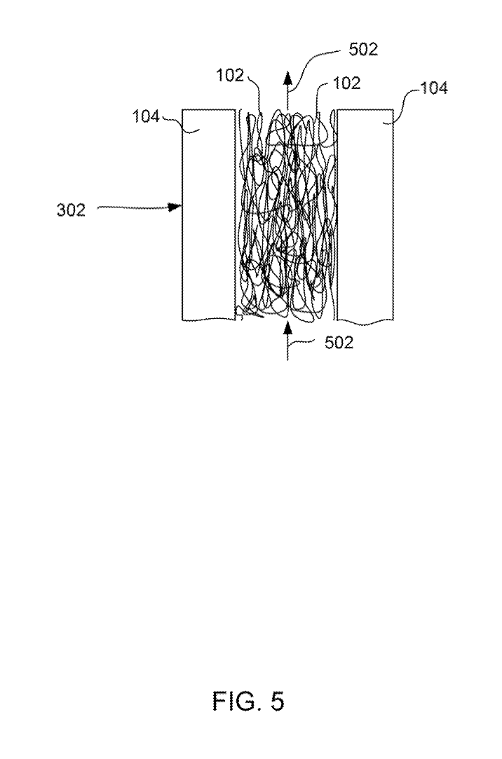

In one embodiment, illustrated in FIG. 5, the heat sealing can be performed such that the porous media 102 is fused together, but retains a porous nature. In this case the outer layer 104 remains intact and impermeable. As can be seen, FIG. 5 shows an enlarged view of the area within the circle 5 in FIG. 3. This shows the edges of layer 304 (FIG. 2) after they have been sealed. In this embodiment, because the layer 102 remains porous, this allows a certain amount of air to flow through the layer 102 as indicated by arrows 502. This passage of air can be useful in relieving air pressure that might otherwise build up within the desiccant device 302 (FIG. 3). For example, when used in a disk drive device, the desiccant structure 302 might experience a change in temperature as the disk drive heats up to operating temperatures. In addition, the device 302 might experience temperature or pressure variations as a result of ambient pressure and temperature changes. If there were no means for relieving this pressure, the outer impermeable membrane 104 might burst, causing the debris from the device 302 to contaminate the disk drive. While the sealed portion of the porous layer 102 allows gas to pass through, the tortuous path of the air passing there-through acts as a filter preventing any contamination whatsoever from escaping the device 302.

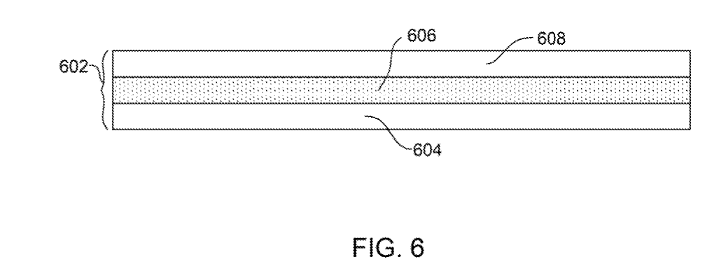

FIG. 6 illustrates an alternate embodiment of the invention, wherein a containment structure can be formed of a laminate layer 602 that includes a porous media 606 that is sandwiched between two impermeable membranes 604, 608 through which a desired gas or vapor can pass by molecular diffusion. The layers, 604, 608 could be the same material, but could also be different materials. For example, the layer which is to be the inner layer in the finished product (e.g. layer 608) can be a material having a lower melting temperature than that of the outer layer (e.g. layer 604). In this case, the inner layer 608 can be melted during heat sealing (described above) without melting or otherwise affecting the outer layer 604. Another advantage of having two impermeable layers 604, 608, is that if the outer layer is damaged (such as by contact with external elements) the inner layer will remain intact to prevent any contamination of the disk drive device (or other device in which the desiccant device might be used).

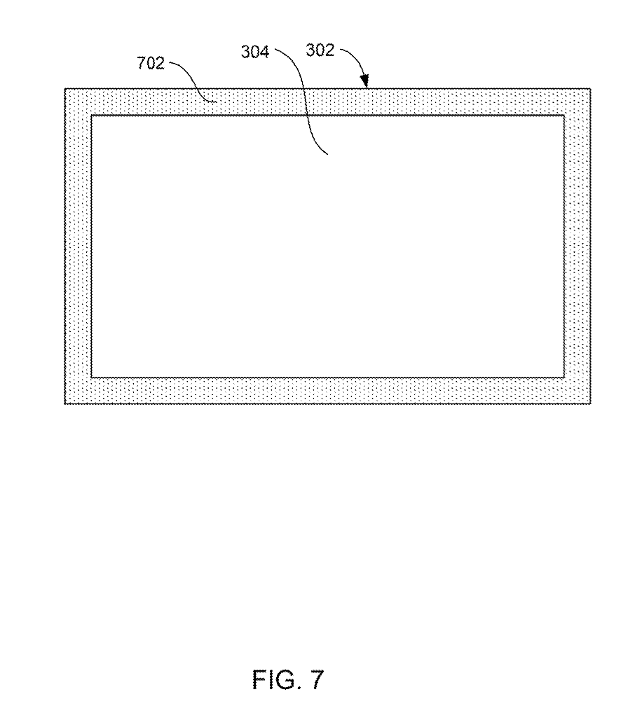

In FIGS. 3 and 4, the desiccant structure was shown as a rectangular structure that has three sides that are sealed. This is by way of example, however, as other shapes and structures are possible as well. For example the structure could be constructed as a rectangular structure where all four sides are sealed as shown in FIG. 7, where the sealed area is indicated as the shaded area designated 702. Furthermore, the structure could be formed in any number of other shapes as well, such as but not limited to round hexagon, etc.

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

1. A desiccant device, comprising:
a containment structure constructed of a laminate layer, the laminate layer comprising a permeable media layer and a thin monolithic membrane bonded to the permeable media layer; and
a vapor absorbing material held within the containment structure.

2. The desiccant device as in claim 1 wherein the laminate layer forms a pouch with the thin monolithic membrane is on the outside of the pouch.

3. The desiccant device as in claim 1 wherein the monolithic membrane layer is an impermeable membrane through with a vapor can pass only by molecular diffusion.

4. The desiccant device as in claim 1 wherein the porous media layer comprises a non-woven fabric.

5. The desiccant device as in claim 1 wherein the porous media layer comprises non-woven polypropylene.

6. The desiccant device as in claim 1 wherein the porous media layer comprises spun bonded polypropylene.

7. The desiccant device as in claim 1 wherein the monolithic membrane layer comprises a polymeric layer of a thickness that allows a desired vapor to pass there-through by molecular diffusion.

8. The desiccant device as in claim 1 the monolithic media comprises non-expanded polytetrafluoroethane.

9. The desiccant device as in claim 1 wherein the laminate layer is termed into a pouch with the porous media layer being on the inside of the pouch and wherein the pouch has heat sealed edges formed such that a gas can flow through the porous membrane at the heat sealed edges to relieve pressure within the pouch.

10. The desiccant device as in claim 9 wherein the porous media layer comprises a non-woven fabric.

11. A desiccant device, comprising:
a containment structure constructed of a laminate layer, the laminate layer comprising first and second non-permeable membranes and a porous media layer sandwiched between the first and second non-permeable membranes; and
a vapor absorbing material held within the containment structure.

12. The desiccant device as in claim 11 wherein the first and second non-permeable membranes are each of a material and thickness to allow a desired vapor to pass there-through by molecular diffusion.

13. The desiccant device as in claim 11 wherein the first and second non-permeable membranes are the same material.

14. The desiccant device as in claim 11 wherein the first and second non-permeable membranes are different materials.

15. The desiccant device as in claim 11 wherein the first and second non-permeable membranes are different materials having different melting points.

16. The desiccant device as in claim 11 wherein the laminate layer is formed into a pouch and wherein the first non-permeable membrane is at the inside of the pouch and the second non-permeable membrane is at the outside of the pouch, and wherein the first non-permeable membrane has a melting point that is lower than that of the second non-permeable membrane.

17. The desiccant device as in claim 16 wherein the pouch has edges that are sealed by heat sealing by edge portions of the first non-permeable membrane.

18. The desiccant device as in claim 11 wherein the porous media comprises a non-woven fabric.

19. The desiccant device as in claim 11 wherein at least one of the non-permeable membranes comprises a polymeric layer of a thickness that allows a desired vapor to pass there-through by molecular diffusion.

20. The desiccant device as in claim 11 at least one of the non-permeable membranes comprises non-expanded polytetrafluoroethane.

21. A magnetic data storage device, comprising:
a housing;
a magnetic media rotatably mounted within the housing;
a suspension arm;
a slider connected with the suspension arm for movement adjacent to a surface of the disk; and
a desiccant device mounted held within the housing, the desiccant device comprising:
a containment structure constructed of a laminate layer, the laminate layer comprising a permeable media layer and a thin monolithic membrane bonded to the permeable media layer; and a vapor absorbing material held within the containment structure.
